(19) United States
(12) Patent Application Publication
(10) Pub. No.: US 2001/0001250 A1
(43) Pub. Date: May 17, 2001

(54) Real image type finder optical system

(75) Inventor: Moriyasu Kanai, Tokyo (JP)

Correspondence Address: GREENBLUM & BERNSTEIN, 1941 ROLAND CLARKE PLACE, RESTON, VA, 20191

(73) Assignee: ASAHI KOGAKU KOGYO KABUSHIKI KAISHA, Tokyo (JP)

(21) Appl. No.: 09/756,718

(22) Filed: Jan. 10, 2001

Related U.S. Application Data
(62) Division of application No. 09/425,629, filed on Oct. 22, 1999.

(30) Foreign Application Priority Data
Oct. 22, 1998 (JP) P10-300899

(51) Int. Cl. G02B 23/00; G02B 5/04

(52) U.S. Cl. 359/431; 359/831; 359/834

(57) ABSTRACT

A real image type finder optical system comprising, in order from the object side, an objective optical system of non-telecentric system, a first prism having a wedge angle of 3°, a second prism, a third prism, and an eyepiece lens. The second prism has a first face as the entrance surface in contact with the back surface of the first prism, a second face forming an angle of 22.5° with respect to the first face and a third face for transmitting the optical axis bend by these second face and first face. The third prism has a first face as the entrance surface spaced in parallel from and confronting the third face of the second prism, a second face forming 45° with respect to the first face in order to bend the optical axis toward the object side at an angle of 90° within a horizontal plane, and a third face formed as roof faces for bending the optical axis bent by the second face toward the first face at an angle of 45° within a horizontal plane. The eyepiece lens is arranged so as to confront the second face of the second prism and be coaxial with the optical axis which is bent by the third face and passes through the second face.

1. This is a division of U.S. patent application Ser. No. 09/425,629, filed Oct. 22, 1999, the contents of which are expressly incorporated by reference herein in its entirety.

### BACKGROUND OF THE INVENTION

2. 1. Field of the Invention

3. The present invention relates to a real image type finder optical system in use for a viewfinder of cameras. The present disclosure relates to subject matter contained in Japanese Patent Application No. Hei 10-300899 (filed on Oct. 22, 1998), which is expressly incorporated herein by reference in its entirety.

4. 2. Description of the Related Art

5. Conventional real image type finder optical systems to be used in compact cameras and the like have, for example, the constitutions disclosed in U.S. Pat. No. 5,640,632. The real image type finder optical system disclosed in FIG. 7 of this publication has general constitution in which a first prism, a second prism, and an eyepiece lens are arranged in order behind its objective optical system of telecentric system and in which roof surfaces are used to reduce the top-to-bottom thickness and the front-to-back length of the finder optical system. The first prism has a first face as an entrance surface, a second face given reflective coating, and a third face as an exit surface. Here, the first face is perpendicular to the optical axis of the objective optical system, the second face is inclined with respect to this first face so that the optical axis transmitted through the first face is turned obliquely relative to the first face, and the third face is perpendicular to this optical axis bent by the second and first face in order. The second prism has a first face confronting the third face of the first prism, a second face inclined with respect to this first face so that the optical axis transmitted through the first face is bent to the object side, and a third face which is roof faces for turning the optical axis bent by the second face toward the first face.

6. Now, in view of total reflection conditions, each prism is ideally made of glass having a high refractive index. However, resin molded articles of lower refractive indexes are often used for the prism to lower costs. For example when a prism is composed of resin having a refractive index on the order of 1.5, the total reflection condition for internal reflection in the prism is that a critical angle θ is 41.8° (=sin⁻1/1.5) Meanwhile, in an objective optical system constituted as a telecentric system, the lens closest to the image formed by the objective optical system is extremely large in outer diameter as compared with the field stop. Besides, an objective optical system, when constituted as a telecentric system, becomes greater in overall length. Accordingly, if objective optical system is intended to be more compact, it is disadvantageous for the objective optical systems to be designed as a telecentric system.

7. If, in view of the foregoing circumstances, the objective optical system of the real image type finder optical system disclosed by the aforementioned publication is changed into a non-telecentric system and each prism is replaced with a resin molded article, then some of the light beams running from the second face of the first prism to the first face will impinge on the first face at incident angles below the critical angle θ of 41.8°. Accordingly, such light beams not satisfying the total reflection condition are to be intercepted. Similarly, in the second prism, some of the light beams running from the first face to the second face will be incident on the second face, and some of light beams running from the third face to the first face be incident on the first face, at incident angles below the critical angle θ of 41.8°. Therefore, such light beams not satisfying the total reflection condition are to be intercepted. These faces, namely, the first face of the first prism and the second face and first face of the second prism, need to combine the function of a reflective face and the function of a transmitting surface (that is, an entrance surface or an exit surface) for transmitting light beams coming from generally perpendicular directions. Accordingly, a method of applying metal coatings on these faces to adjust their reflective conditions cannot be adopted for the prevention of light beam interception Hence, the entire real image type finder optical system must be constituted so that the incident angles of the light beams to these faces are adjusted to satisfy the total reflection conditions in these faces.

### SUMMARY OF THE INVENTION

8. An object of the present invention is to devise the shapes of resin molded prisms to satisfy the total reflection condition for oblique-incident light beams with respect to the prisms' reflective faces serving also as transmitting surfaces, and to provide thereby a real image type finder optical system which can solve the problem of light beam interception occurring in the cases where an objective optical system of non-telecentric system and resin-molded prisms are adopted.

9. A real image type finder optical system according to a first aspect of the present invention contrived to achieve the foregoing object has an objective optical system and an eyepiece lens arranged in parallel to each other. In the real image type finder optical system, an optical axis extending from the objective optical system to the eyepiece lens is bent at least within a prescribed plane. This real image type finder optical system comprises: a first prism having a first face as an entrance surface for transmitting without deviation an optical axis transmitted through the objective optical system and a second face inclined with respect to this first face; a second prism having a first face as an entrance surface placed in parallel with the second face of this first prism, a second face as a reflective face inclined with respect to this first face in the same direction as the inclined direction of the second face of the first prism with respect to the first face of the same and a third face as an exit surface for transmitting without deviation an optical axis bent in order by these second face and first face; and a third prism having a first face as an entrance surface for transmitting without deviation an optical axis transmitted through the second prism, a second face inclined to the first face in order to bend the optical axis to object side and confronting an entrance surface of the eyepiece lens and a third face for bending the optical axis bent by the second face toward the first face so as to direct the optical axis to a direction coaxial with the eyepiece lens via the first face and the second face.

10. In such constitution, it is possible for the light beams reflected by the second face of the second prism to be set sufficiently large in incident angle with respect to the first face. As a result, all the light beams satisfy the total reflection condition on the first face of the second prism even in the cases where the objective optical system is a non-telecentric system and the second prism is a resin molded article. This eliminates the interception of light beams from this first face.

11. A real image type finder optical system according to a second aspect of the present invention has an objective optical system and an eyepiece lens arranged in parallel to each other. In the real image type finder optical system, an optical axis extending from the objective optical system to the eyepiece lens is bent at least within a prescribed plane. This real image type finder optical system comprises: a first prism having a first face as an entrance surface for transmitting without deviation an optical axis transmitted through the objective optical system, a second face as a reflective face inclined with respect to this first face at an angle greater than 23.5° and smaller than 26° and a third face as an exit surface for transmitting without deviation an optical axis bent in order by these second face and first face; and a second prism having a first face as an entrance surface for transmitting without deviation an optical axis transmitted through this first prism, a second face inclined to the first face in order to bend the optical axis to object side, the second face confronting an entrance surface of the eyepiece lens and a third face for bending an optical axis bent by the second face toward the first face so as to direct the optical axis to a direction coaxial with the eyepiece lens via the first face and the second face.

12. In such constitution, it is possible for the light beams reflected by the second face of the first prism to be set sufficiently large in incident angle relative to the first face without using a correcting prism such as the first prism in the first aspect. As a result, all the light beams satisfy the total reflection condition on the first face of the first prism even in the cases where the objective optical system is a non-telecentric system and the first prism is a resin molded article. This accordingly eliminates the interception of light beams from this first face. It should be noted here that the angle of the second face of the first prism with respect to the first face exceeding 26° undesirably increases the overall size of the prism

### BRIEF EXPLANATION OF THE DRAWINGS

13. The invention will be described below in detail with reference to the accompanying drawings, in which:

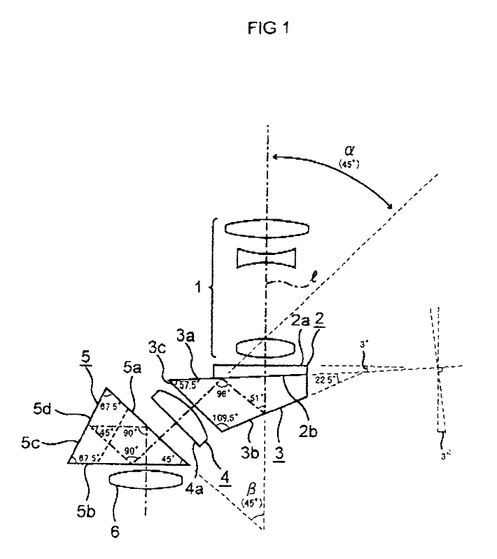

14. FIG. 1 is a plan view of the real image type finder optical system according to a first embodiment of the present invention; and

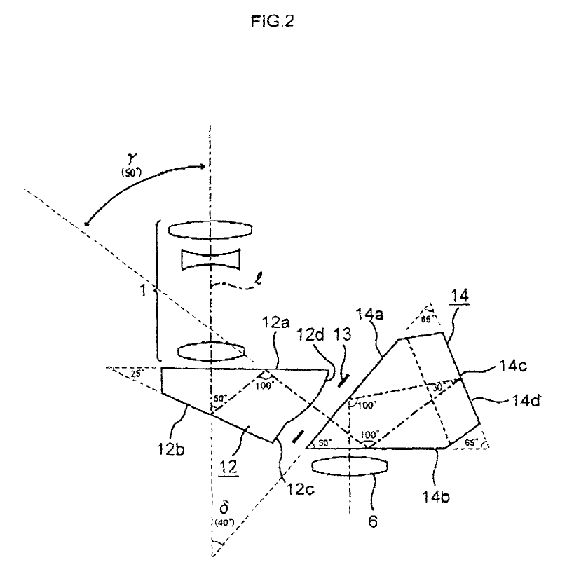

15. FIG. 2 is a plan view of the real image type finder optical system according to a second embodiment of the present invention.

### DETAILED DESCRIPTION OF THE PREFERRED EMBODIMENTS

16. Hereinafter, embodiments of the present invention will be described in conjunction with the accompanying drawings.

### First Embodiment

17. FIG. 1 is a plan view of the real image type finder optical system according to a first embodiment of the present invention. The top-to-bottom direction in the figure corresponds to the front-to-back direction of this real image type finder optical system, in other words, the direction connecting an object as the subject to be shot and a photographer's eye.

18. As shown in FIG. 1, the real image type finder optical system according to the first embodiment comprises, in order from the object side along a optical path, an objective optical system 1, a first prism 2, a second prism 3, a condenser lens 4, a third prism 5 and an eyepiece lens 6. In this connection, the optical axis extending from the objective optical system 1 to the eyepiece lens 6 is hereinafter referred to as finder optical axis 1.

19. The objective optical system 1 is a zoom lens composed of three pieces of lens in three groups, and forms a real image of a not-illustrated object into vicinity of a focal plane 4a of the condenser lens 4 at a magnification corresponding to its overall focal length. This objective optical system 1 is constituted as a non-telecentric system so as to avoid its diameter becoming large.

20. The first prism 2 is an optical wedge with its first face 2a and second face 2b making therebetween an angle of 3°. The first face 2a confronts the exit plane of the objective optical system 1 and put in a direction perpendicular to the finder optical axis 1. Accordingly, the optical axis coming out of the objective optical system 1 enters the first prism 2 without being deviated by the first face 2a, and goes to the second face 2b.

21. The second face 2b of the first prism 2 is placed in contact with a first face 3a of the second prism 3. This second prism 3 is formed of transparent resin having a refractive index of 1.5. Therefore, the total reflection condition of the second prism 3 in its internal reflection is that a critical angle θ is 41.8° (=sin⁻¹ 1/1.5). The second prism 3 has a prismatic shape with its tetragonal bottom surface put on the plane of FIG. 1. The second prism 3 has side faces including the above-mentioned first face 3a, a second face 3b opposed to the first face 3a at an angle of 22.5°, and a third face 3c as an exit surface adjoining the first face 3a at an angle of 48° and adjoining the second face 3b at an angle 109.5°.

22. The second prism 3 is arranged in contact with the first prism 2 so that the second face 3b thereof is inclined in the same direction as the inclined direction of the second face 2b with respect to the first face 2a of the first prism 2. Therefore, the finder optical axis 1 transmitted through the first face 3a of the second prism 3 forms an angle of 25.5° with the normal line of the second face 3b. Here, onto the second face 3b is applied reflective coating of aluminum. Consequently, all the light beams having entered the second prism 3 through the first face 3a are reflected by the second face 3b, so that the finder optical axis 1 is bent toward the first face 3a at an angle of 51°. The finder optical axis 1 directed from the second face 3b to the first face 3a and the normal line of the first face 3a make an angle of 48°, which means that the respective light beams reflected from the second face 3b are re-incident on the first face 3a at incident angles of 48° on average. Since this average incident angle of 48° is sufficiently larger than the aforementioned critical angle θ of 41.8°, almost all of the light beams re-incident on the first face 3a with some divergence are totally reflected by this first face 3a, so that the finder optical axis 1 is bent at an angle of 96° within the plane of FIG. 1.

23. The finder optical axis 1 bent thus inclines at 45° with respect to the initial optical axis of the objective optical system 1 as shown by α on FIG. 1. The third face 3c crosses the finder optical axis 1 at right angles so that the finder optical axis 1 bent at the first face 3a passes through the third face 3c without being deviated by this third face 3c, and enters the condenser lens 4.

24. The condenser lens 4 is a planoconvex lens arranged with its convex surface toward the second prism 3. The back surface thereof is the focal plane 4a, on which is formed the real image (inverted image) of the object formed by the objective optical system 1. This condenser lens 4 provides coincidence between the exit pupil of the objective optical system 1 and the entrance pupil of the eyepiece lens 6.

25. The side faces of the above-mentioned third prism 5 comprise a first face 5a, a second face 5b and a third face 5c. The first face 5a serving as the entrance surface is arranged to confront the third face 3c of the second prism 3 via the condenser lens 4 and be perpendicular to the finder optical axis 1. The second face 5b serving as the exit surface adjoins the eyepiece-side edge of the first face 5a with an angle of 45° therebetween. The third face 5c is composed of roof faces comprising a pair of reflective faces which meet each other with a right angle therebetween along a ridge line 5d tilted by 67.5° with respect to both the first face 5a and the second face 5b. This third prism 5 is also molded of transparent resin having a reflective index of 1.5. Accordingly, this third prism 5 also has the critical angle θ of 41.8°as the total reflection condition in its internal reflection.

26. Since the finder optical axis 1 transmitted through the condenser lens 4 inclines at 45° with respect to the initial optical axis of the objective optical system 1, the first face 5a of the third prism 5 is placed at 45° with respect to the initial optical axis of the objective optical system 1 as shown by β on FIG. 1. Consequently, the finder optical axis 1 is transmitted through the first face 5a without being deviated by this first face 5a. The finder optical axis 1 running from the first face 5a to the second face 5b and the normal line of the second face 5b make an angle of 45°, so that the respective light beams transmitted through the first face 5a are incident on the second face 5b at incident angles of 45° on average. Since this average incident angle of 45° is sufficiently larger than the aforementioned critical angle θ of 41.8°, almost all of the light beams incident on the second face 5b with some divergence are totally reflected by this second face 5b, and the finder optical axis 1 is bent toward the object side at an angle of 90° within the plane of FIG. 1.

27. The light beams totally reflected by the second face 5b are then incident on the third face 5c. The ridge line 5d between the respective roof faces constituting the third face 5c inclines by 67.5° with respect to the second face 5b, and thus inclines also by 67.5° with respect to the finder optical axis 1. In addition, each roof face is tilted by 45° with respect to the plane including the ridge line 5d and the finder optical axis 1. According to the above-mentioned, the normal line of each roof face and the finder optical axis 1 form therebetween an angle of 49.2°. Consequently, the light beams total-reflected from the second face 5b are incident on the respective roof faces constituting the third face 5c at incident angles of 49.2° on average. Since this average incident angle of 49.2° is sufficiently larger than the aforementioned critical angle θ of 41.8°, almost all of the light beams incident on the respective roof faces of the third face 5c with some divergence are totally reflected by this third face 5c while being inverted upside down, and the finder optical axis 1 is bent toward the first face 5a at an angle of 45° within the plane of FIG. 1.

28. The light beams totally reflected by the third face 5c are then re-incident on the first face 5a. This first face 5a is inclined by 67.5° with respect to the ridge line 5d of the third face 5c. Accordingly, the finder optical axis 1 and the normal line of the first face 5a form an angle of 45°, so that the respective light beams are re-incident on the first face 5a at incident angles of 45° on average. Since this average incident angle of 45° is sufficiently larger than the aforementioned critical angle of 41.8°, almost all of the light beams re-incident on the first face 5a with some divergence are totally reflected by this first face 5a, bending the finder optical axis 1 at 90° to the eyepiece lens side within the plane of FIG. 1.

29. The finder optical axis 1 bent thus is in parallel to the initial optical axis of the objective optical system 1 as well as perpendicular to the second face 5b. Therefore, the light beams totally reflected by the first face 5a pass through this second face 5b to exit the third prism 5.

30. The eyepiece lens 6, which is arranged to confront the second face 5b of the third prism 3 and be coaxial with the finder optical axis 1, is placed at a position of −1 diopter with respect to the focal plane 4a along the finder optical axis 1 as its standard position.

31. According to the real image type finder optical system of the first embodiment constituted as described above, light beams to be reflected are incident on each of the reflective faces of the prisms 3 and 5 which also serves as a transmitting surface, i.e. an entrance surface or an exit surface (namely, the first face 3a of the second prism 3, and the first face 5a and second face 5b of the third prism 5), at incident angles sufficiently larger than the critical angle for the internal reflection at the face. This prevents most of light beam from being intercepted even if these prisms 3 and 5 are made of resin having lower refractive indexes and the objective optical system 1 is constituted as a non-telecentric system.

32. While in the first embodiment the third face 5c of the third prism 5 is constituted as the roof faces, the third face 5c may be formed as a flat face and the second face 3b of the second prism 3 be formed as roof faces. In this case, the third face 5c of the third prism 5 requires reflective coating of aluminum thereon since it does not satisfy the total reflection condition for the light beams. Meanwhile, the second face 3b of the second prism 3 constituted as the roof faces does satisfy the total reflection condition for the light beams, which eliminates the need for reflective coating on the second face 3b. It should be noted that the formation of roof faces on the second face 3b of the second prism 3 increases the second prism 3 in overall size, and hence roof faces are more preferably formed on the third face 5c of the third prism 5 which suffers no variation in size resulting from the presence or absence of roof faces.

### Second Embodiment

33. In comparison with the above-described first embodiment, a second embodiment of the present invention is to dispense with the first prism as a correcting prism to allow cost reduction.

34. FIG. 2 is a plan view of the real image type finder optical system according to the second embodiment of the present invention. Here, the top-to-bottom direction in the figure corresponds to the front-to-back direction of this real image type finder optical system, in other words, the direction connecting an object as the subject to be shot and a photographer's eye.

35. As shown in FIG. 2, the real image type finder optical system according to the second embodiment comprises, in order from the object side along a optical path, an objective optical system 1, a first prism 12, a field frame 13, a second prism 14 and an eyepiece lens 6. In this connection, the optical axis extending from the objective optical system 1 to the eyepiece lens 6 is hereinafter referred to as finder optical axis 1.

36. The objective optical system 1 is a zoom lens composed of three pieces of lens in three groups. The objective optical system 1 forms a real image of a not-illustrated object as an aerial image on the finder optical axis 1 (on the plane bordered by the field frame 13) between the first prism 12 and the second prism 14 at a magnification corresponding to its overall focal length.

37. This objective optical system 1 is constituted as a non-telecentric system so as to avoid larger lens apertures thereof.

38. The first prism 12 has a substantially prismatic shape with its substantially tetragonal bottom surface put on the plane of FIG. 2. The first prism 12 has side faces including a first face 12a as the entrance surface, a second face 12b, and a third face 12c as the exit surface. The first face 12a is arranged to confront the objective optical system 1 and perpendicular to the finder optical axis 1. The second face 12b is opposed to the first face 12a at an angle of 25°. The third face 12c adjoins the first face 12a on the side where the first face 12a and the second face 12b draw apart from each other. This first prism 12 is formed of transparent resin having a refractive index of 1.5. Hence, the first prism 12 has a critical angle θ of 41.8°(=sin⁻¹ 1/1.5) as the total reflection condition in its internal reflection.

39. The finder optical axis 1 is transmitted through the first face 12a of the first prism 12 without being deviated by this first face 12a. The finder optical axis 1 transmitted through the first face 12a is then bent by the second face 12b at an angle of 50° toward the first face 12a. Since the second face 12b has reflective coating of aluminum applied thereto, all the light beams having exited from the objective optical system 1 and entered into the first prism 12 through the first face 12a are reflected by this second face 12b to be re-incident on the first face 12a. The finder optical axis 1 directed from the second face 12b to the first face 12a forms an angle of 50° with the normal line of the first face 12a, so that the respective light beams reflected from the second face 12b are re-incident on the first face 12a at incident angles of 50° on average. Since this average incident angle of 50° is sufficiently larger than the aforementioned critical angle θ of 41.8°, almost all of the light beams re-incident on the first face 12a with some divergence are totally reflected by the first face 12a, so that the finder optical axis 1 is bent at an angle of 100° within the plane of FIG. 2.

40. The finder optical axis 1 thus bent is transmitted through the third face 12c. In a circular area on the third face 12c around the finder optical axis 1 is formed a positive-powered lens surface 12d having its center of curvature on the finder optical axis 1. Accordingly, the finder optical axis 1 is not deviated by the third face 12c. The lens surface 12d functions as a condenser lens for providing coincidence between the exit pupil of the objective optical system 1 and the entrance pupil of the eyepiece lens 6.

41. In the field frame 3, the real image of the object is formed by the objective optical system 1 as an inverted image.

42. The side faces of the above-mentioned second prism 14 comprise a first face 14a as the entrance surface, a second face 14b as the exit surface, and a third face 14c. The first face 14a is arranged to confront the third face 12c of the first prism 12 via the field frame 13 and be perpendicular to the finder optical axis 1. The second face 14b adjoins the eyepiece-side edge of the first face 14a with an angle of 50° therebetween. The third face 14c is composed of roof faces comprising a pair of reflective faces which meet each other with a right angle therebetween along a ridge line 14d tilted by 65° with respect to both the first face 14a and the second face 14b. This second prism 14 is also formed of transparent resin having a refractive index of 1.5. Therefore, the second prism also has a critical angle θ of 41.8° as the total reflection condition for its internal reflection.

43. The finder optical axis 1 is transmitted through the first face 14a of the second prism 14 without being deviated by this first face 14a. Since the finder optical axis 1 transmitted through the first face 14a inclines at 50° with respect to the initial optical axis of the objective optical system 1, the first face 14a is arranged to incline at 40° with respect to the initial optical axis of the objective optical system 1. The finder optical axis 1 directed from the first face 14a to the second face 14b forms an angle of 50° with the normal line of the second face 14b as shown by γ on FIG. 2, so that the respective light beams transmitted through the first face 14a are incident on the second face 14b at incident angles of 50° on average as shown by □ on FIG. 2. Since this average incident angle of 50° is sufficiently larger than the aforementioned critical angle θ of 41.8°, all the light beams incident on the second face 14b with some divergence are totally reflected by this second face 14b, and the finder optical axis 1 is bent toward the object side at an angle of 100° within the plane of FIG. 2.

44. The light beams totally reflected by the second face 14b are then incident on the third face 14c. The ridge line 14d between the respective roof faces constituting the third face 14c inclines at 65° with respect to the second face 14b, and therefore inclines at 75° with respect to the finder optical axis 1. In addition, each roof face is tilted by 45° with respect to the plane including the ridge line 14d and the finder optical axis 1. According to the above-described, the normal line of each roof face and the finder optical axis 1 form an angle of 47.1°. Consequently, the light beams total-reflected from the second face 14b are incident on these roof faces constituting the third face 14c at incident angles of 47.1° on average. Since this average incident angle of 47.1° is sufficiently larger that the aforementioned critical angle θ0 of 41.8°, all the light beams incident on the respective roof faces of the third face 14c with some divergence are totally reflected by this third face 14c while being inverted upside down, so that the finder optical axis 1 is bent toward the first face 14a at an angle of 30° within the plane of FIG. 2.

45. The light beams totally reflected by the third face 14c are then re-incident on the first face 14a. This first face 14a inclines at 65° with respect to the ridge line 14d of the third face 14c. Accordingly, the finder optical axis 1 and the normal line of the first face 14a form an angle of 50°, and the respective light beams are re-incident on the first face 14a at incident angles of 50° on average. Since this average incident angle of 50° is sufficiently larger than the aforementioned critical angle θ of 41.8°, all the light beams re-incident on the first face 14a are totally reflected by this first face 14a, and the finder optical axis 1 is bent to the eyepiece lens side at an angle of 100° within the plane of FIG. 2.

46. The finder optical axis 1 bent thus is in parallel to the initial optical axis of the objective optical system 1 and perpendicular to the second face 14b. Therefore, the light beams totally reflected by the first face 14a pass through this second face 14b to exit from the second prism 14.

47. The eyepiece lens 6, which is arranged to confront the second face 14b and be coaxial with the finder optical axis 1, is placed at a position of −1 diopter with respect to the field frame 13 along the finder optical axis 1 as its standard position.

48. According to the real image type finder optical system of the second embodiment constituted as described above, light beams to be reflected are incident on each of the reflective faces of the prisms 12 and 14 which also serves as a transmitting surface, i.e. an entrance surface or an exit surface (namely, the first face 12a of the first prism 12, and the first face 14a and second face 14b of the second prism 14), at incident angles sufficiently larger than the critical angle for the internal reflection at the face. This completely prevents light beam from being intercepted even if these prisms 12 and 14 are made of resins having lower refractive indexes and the objective optical system 1 is formed as a non-telecentric system.

49. While in the second embodiment the angle formed by the first face 12a and second face 12b of the first prism 12 is 25°, the angle therebetween may be changed to some extent. It should be noted here that the angle equal to or smaller than 23.5° precludes complete satisfaction of the total reflection condition for the light beams re-incident on the first face 12a, resulting in interceptions of some light beams. In contrast, the angle equal to or greater than 26° does satisfy the total reflection condition for the light beams re-incident on the first face 12a, while it leads to an increase in overall sizes of the first prism 12 and the second prism 14.

50. Moreover, while in the second embodiment the third face 14c of the second prism 14 is constituted as the roof faces, the third face 14c of the second prism 14 may be formed as a flat face and the second face 12b of the first prism 12 be formed as roof faces. In this case, the third face 14c of the second prism 14 requires reflective coating of aluminum thereon since it does not satisfy the total reflection condition for the light beams. Meanwhile, the second face 12b of the first prism 12 as a roof surface satisfies the total reflection condition for the light beams to dispense with reflective coating.

51. According to the real image type finder optical systems of the present invention constituted as described above, the problem of light beam interception can be solved even in the cases where the objective optical system is a non-telecentric system and the prisms is molded articles of resin, because the total reflection condition is satisfied for light beams obliquely incoming on the reflective faces of the aforesaid prisms which also serve as transmitting surfaces.

52. While there has been described what are at present considered to be preferred embodiments of the invention, it will be understood that various modifications may be made thereto, and it is intended that the appended claims cover all such modifications as fall within the true spirit and scope of the invention.

We claim:

1. A real image type finder optical system having an objective optical system and an eyepiece lens arranged so that their optical axes are parallel to each other, in which an optical axis extending from said objective optical system to said eyepiece lens is bent at least within a prescribed plane, comprising:
a first prism having a first face as an entrance surface for transmitting without deviation an optical axis transmitted through said objective optical system and a second face inclined with respect to the first face;
a second prism having a first face as an entrance surface placed in parallel with the second face of said first prism, a second face as a reflective face inclined with respect to the first face in the same direction as the inclined direction of the second face of said first prism with respect to the first face of the same and a third face as an exit surface for transmitting without deviation the optical axis bent in order by the second face and the first face; and
a third prism having a first face as an entrance surface for transmitting without deviation the optical axis transmitted through said second prism, a second face inclined to said first face in order to bend said optical axis to object side, said second face confronting an entrance surface of said eyepiece lens and a third face for bending the optical axis bent by said second face toward said first face so as to direct the optical axis to a direction coaxial with said eyepiece lens via reflection at said first face and transmission at said second face.

2. The real image type finder optical system according to claim 1, wherein
the third face of said third prism is formed as roof faces comprising a pair of reflective faces meeting each other with a right angle therebetween along a ridge line parallel to said prescribed plane.

3. The real image type finder optical system according to claim 1, wherein
the first face and the second face of said first prism form an angle of 2° through 5°.

4. The real image type finder optical system according to claim 1, wherein
a condenser lens is arranged on the optical axis between the third face of said second prism and said first face of said third prism.

5. The real image type finder optical system according to claim 1, wherein,
the optical axis transmitted through the third face of said second prism is inclined generally at 45° with respect to the direction of the optical axis transmitted through the first face of said first prism.

6. A real image type finder optical system having an objective optical system and an eyepiece lens arranged so that their optical axes are parallel to each other, in which an optical axis extending from said objective optical system to said eyepiece lens is bent at least within a prescribed plane, comprising:
a first prism having a first face as an entrance surface for transmitting without deviation an optical axis transmitted through said objective optical system, a second face as a reflective face inclined with respect to the first face at an angle greater than 23.5° and smaller than 26° and a third face as an exit surface for transmitting without deviation an optical axis bent in order by the second face and the first face; and
a second prism having a first face as an entrance surface for transmitting without deviation an optical axis transmitted through said first prism, a second face inclined to said first face in order to bend said optical axis to object side, said second face confronting an entrance surface of said eyepiece lens, and a third face for bending the optical axis bent by said second face toward said first face so as to direct the optical axis to a direction coaxial with said eyepiece lens via reflection at said first face and transmission at said second face.

7. The real image type finder optical system according to claim 6, wherein
the third face of said second prism is formed as roof faces comprising a pair of reflective faces meeting each other with a right angle therebetween along a ridge line parallel to said prescribed plane.

8. The real image type finder optical system according to claim 6, wherein
the third face of said first prism has a positive power.
